(19) United States
(12) Patent Application Publication
(10) Pub. No.: US 2002/0170763 A1
(43) Pub. Date: Nov. 21, 2002

(54) Electric scooter with selectable speed ranges

(76) Inventor: Arthur R. Townsend, Lawton, OK (US)

Correspondence Address: James T. Robinson, Exclusivity-Law, Inc., 222 East Main Street, Norman, OK, 73069-1303, US

(21) Appl. No.: 09/860,152

(22) Filed: May 16, 2001

(51) Int. Cl. B62K 11/00; B60K 1/00

(52) U.S. Cl. 180/220; 180/65.1

(57) ABSTRACT

An improved electric scooter provides a speed range controller for selection between a plurality of speed ranges. The speed range controller includes a switch for switching between a first switch position wherein a fixed resistor is placed in series with the potentiometer and a second switch position wherein the potentiometer is the only resistance connected to the motor controller. In the first switch position the maximum control voltage sensed by the motor controller is reduced by the presence of the fixed resistor to a value less than the reference voltage, and the maximum speed of the DC motor within the first speed range is less than the maximum speed dictated by the battery voltage and the DC motor specifications. In the second switch position, the maximum control voltage sensed by the motor controller is the reference voltage, and the maximum speed of the DC motor is dictated by the battery voltage and the DC motor specifications.

### BACKGROUND OF THE INVENTION

1. Field of the Invention

This invention relates to an electric scooter and, more particularly, but not by way of limitation, to an electric scooter having a twist throttle and conveniently selectable speed/power ranges determined by a speed/power range controller.

2. Discussion

Electric scooters have increased in popularity in the last few years due to several factors. Costs have dropped. Electric scooters make little noise and are considered more friendly to the environment than gasoline powered scooters. The efficiency of electric batteries and motors has risen so that electric scooters are now a viable means of transportation over short-to-medium distances in highly populated areas.

Even with these improvements, however, until now scooters have had inherent range and speed limitations which make them unacceptable to many riders. The variable speed electric scooter of applicant's invention is a faster, longer range, and more powerful electric scooter than those previously available.

DC electric motors are either of “brushed” or “brushless” design. Brushed motors do not require a motor controller, although brushed motors often use a motor controller to provide for variable speed. Brushless motors eliminate the brushes and commutator, so they are cleaner, faster, more efficient, quieter, and more reliable than brushed motors. Brushless motors require a motor controller. It is known in the prior art to use an external user-adjustable potentiometer to provide speed-control input to the motor controller.

It is well known in the art to provide a motor controller mounted separately from the motor. The motor controller can also be housed inside the motor case. U.S. Pat. No. 6,104,112 discloses a brushless DC motor in a small, compact, completely enclosed unit which includes a motor controller. Thus no separate motor controller is required. Whether the motor controller is mounted separately or is included in an enclosed unit with the motor, the motor and/or motor controller is susceptible to overheating. When that happens, the motor and motor controller must be shut down and allowed to cool before resuming operation.

It will be understood by one of ordinary skill in the art that, in discussing the operation of an electric scooter powered by an electric motor controlled by a motor controller, more power supplied to the motor generally equates to a higher speed of the scooter and less power supplied to the motor generally equates to a slower speed of the scooter. As used herein, the terms speed and power will sometimes be used interchangeably. Likewise, the terms speed range and power range will sometimes be used interchangeably to indicate the extent to which the motor operates at a speed/power relative to the motor's maximum speed/power capacity.

Prior art teaches a battery-powered DC motor, wherein the speed of the DC motor is determined by a motor controller, the motor controller applies a reference voltage across a potentiometer and the potentiometer provides a motor control voltage to the motor controller, and the motor controller senses the motor control voltage and adjusts the speed of the DC motor based on the motor control voltage.

### SUMMARY OF THE INVENTION

The electric scooter of the present invention includes a speed range controller which permits selection between a plurality of speed ranges. The speed range controller includes a switch for switching between a first switch position wherein a fixed resistor is placed in series with the potentiometer and a second switch position wherein the potentiometer is the only resistance connected to the motor controller. In the first switch position the maximum control voltage sensed by the motor controller is reduced by the presence of the fixed resistor to a value less than the reference voltage, and the maximum speed of the DC motor within the first speed range is less than the maximum speed dictated by the battery voltage and the DC motor specifications. In the second switch position, the maximum control voltage sensed by the motor controller is the reference voltage, and the maximum speed of the DC motor is dictated by the battery voltage and the DC motor specifications.

An object of the present invention is to provide an electric scooter with multiple speed ranges wherein the speed within each speed range is controlled by a twist throttle.

Yet another object of the present invention is to provide an electric scooter wherein a switchlock (i.e., a keyed rotary switch) is used to select the speed range.

Yet another object of the invention is to provide an electric scooter wherein a parent can limit the maximum speed of the scooter while permitting a child to further limit the maximum speed, subject to the maximum speed previously determined by the parent.

Yet another object of the invention is to provide an electric scooter which eliminates the problems of overheating in the DC motor and motor controller.

Yet another object of the invention is to provide an electric scooter with a form of cruise control.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is an electric scooter according to the present invention.

FIG. 2 is an enlarged view of the battery tray of the electric scooter shown in FIG. 1.

FIG. 3 is another view of the battery tray shown in FIG. 2 showing a keyswitch and a recharging jack.

FIG. 4 is a detailed view, partially cut away, of the battery tray shown in FIG. 3.

FIG. 5 is a view of the rear portion of the frame of the electric scooter shown in FIG. 1.

FIG. 6 is a view of a motor assembly according to the present invention, wherein the motor is a brushless DC motor having an internal controller.

FIG. 7 is another view of the motor assembly of FIG. 6.

FIG. 8 is an exploded view of the motor assembly of FIG. 6, the rear portion of the frame as depicted in FIG. 5, the battery tray shown in FIGS. 2-4, together with a rear wheel assembly and a toothed drive belt.

FIG. 9 shows the motor assembly of FIG. 8 attached to the battery tray and the frame.

FIG. 10 is a block diagram showing the operation of the electric scooter of FIG. 1 in which the motor drives a toothed drive belt connected to a sprocketed rear wheel.

FIG. 11 is a block diagram showing the operation of the electric scooter of FIG. 1 in which the motor drives a drive chain is connected to a sprocketed rear wheel.

FIG. 12 is a block diagram showing the operation of the electric scooter of FIG. 1 in which the motor drives a drive V-belt is connected to a sheaved rear wheel.

FIG. 13 is a schematic diagram incorporating the brushless DC motor of FIG. 6 to provide an electric scooter having a speed range controller with a single fixed speed range.

FIG. 14 is a schematic diagram of a speed range controller having two fixed speed ranges.

FIG. 15 is a schematic diagram of a speed range controller having three fixed speed ranges.

FIG. 16 is schematic diagram of a speed range controller having N+1 fixed speed ranges.

FIG. 17 is a schematic diagram of a speed range controller having a single variable speed range wherein the motor can attain maximum speed.

FIG. 18 is a schematic diagram of a speed range controller having one fixed speed range and one variable speed range wherein the motor can attain maximum speed.

FIG. 19 is a schematic diagram of a speed range controller having two variable speed ranges, wherein the first variable speed range has a maximum speed which is subject to the second variable speed range.

FIG. 20 is a schematic diagram of a speed range controller having two variable speed ranges, the first variable speed range having a maximum speed which is subject to a fixed speed range and a second variable speed range wherein the motor can attain maximum speed.

FIG. 21 is a schematic diagram incorporating the brushless DC motor of FIG. 6 to provide an electric scooter having a speed range controller which both controls a relay which connects the battery to the motor (including an internal motor controller) and, simultaneously, provides two fixed speed ranges.

FIG. 22 shows another embodiment of the present invention wherein a brushless DC motor having three mounting tabs is secured to the scooter frame by struts attached to the frame on one end and to the mounting tabs on the other.

FIG. 23 is another view of the brushless DC motor of FIG. 22, with the frame partially cut away.

FIG. 24 is another view of the brushless DC motor of FIG. 23, as viewed from the rear of the electric scooter.

### DETAILED DESCRIPTION OF THE INVENTION

In the following description of the invention, like numerals and characters designate like elements throughout the figures of the drawings.

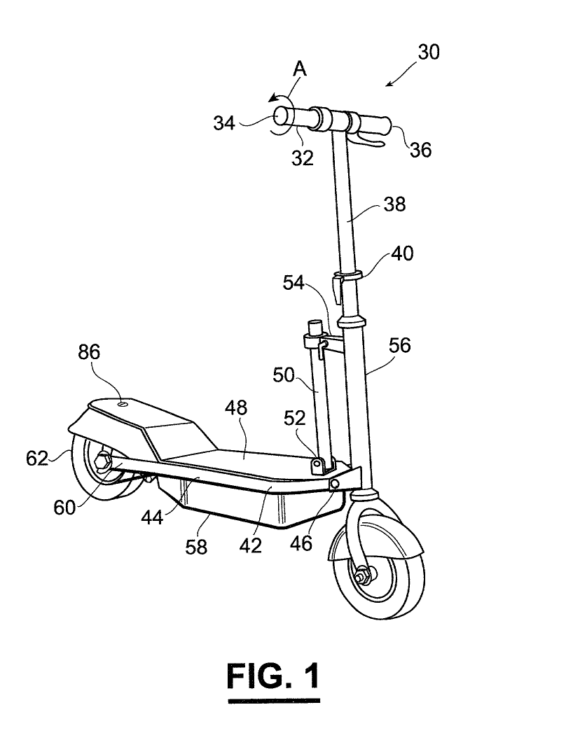

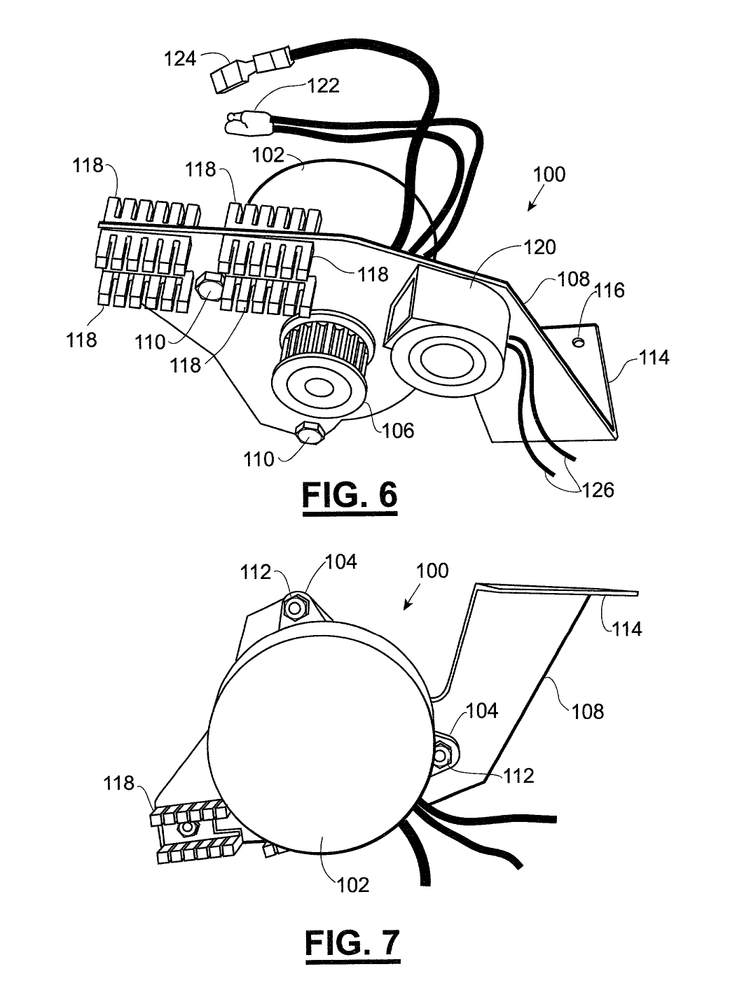

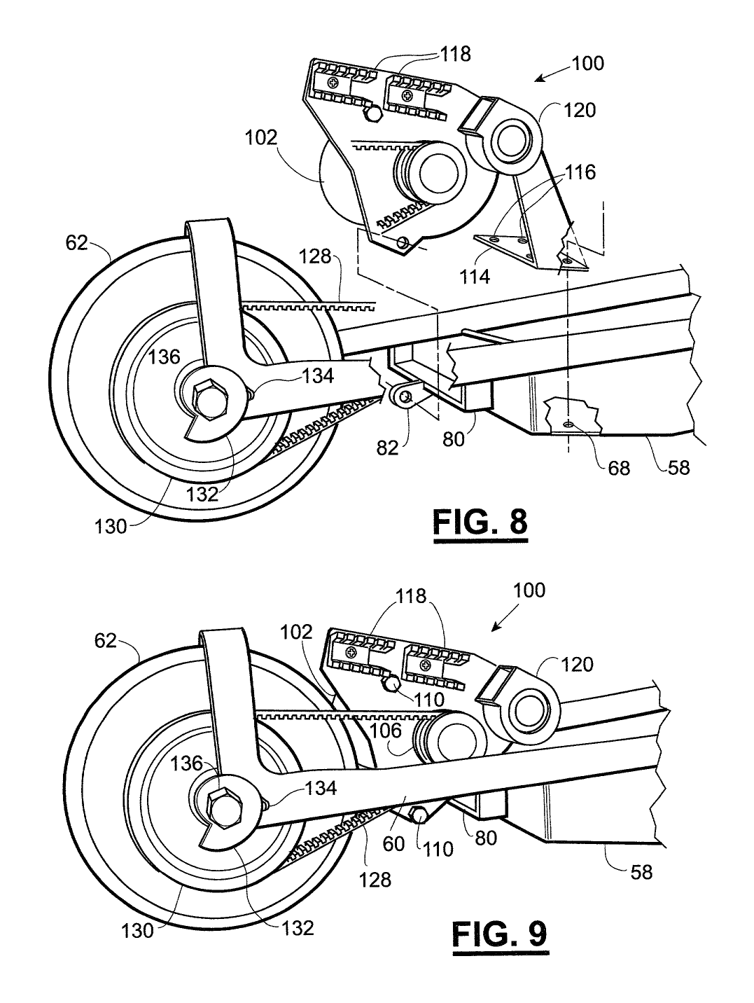

Referring generally to the drawings and more particularly to FIGS. 1-4, an electric scooter 30 includes a twist throttle 32 attached to a right handlebar 34. Handlebars 34 and 36 (left handlebar) are attached to a telescoping handlebar mast 38 held in place by a locking clamp 40. The handlebar mast 38 is attached to a front portion 42 of the frame 44 by a hinge 46. The handlebar mast 38 is deployable between a riding position, as illustrated in FIG. 1, and a storage position (not shown), wherein the telescoping handlebar mast 38 collapses and pivots at the hinge 46 to the storage position wherein the locking clamp 40 rests close to a deck lid 48. A brace 50 is attached at its lower end to a u-shaped bracket 52 and slides in a brace locking clamp 54 attached to a barrel portion 56 of the telescoping handlebar mast 38. To ensure the telescoping handlebar mast 38 does not pivot at the hinge 46 during use, the brace locking clamp 54 is tightly secured to the upper end of the brace 50. A battery tray 58 encloses two 12-volt batteries (not shown) connected in series. A rear portion 60 of the frame 44 receives a rear wheel 62 (sometimes also referred to herein as the drive wheel), a motor assembly 100 (See FIGS. 6-9), a toothed drive belt 128 (See FIGS. 8-9), and a brake assembly (not shown).

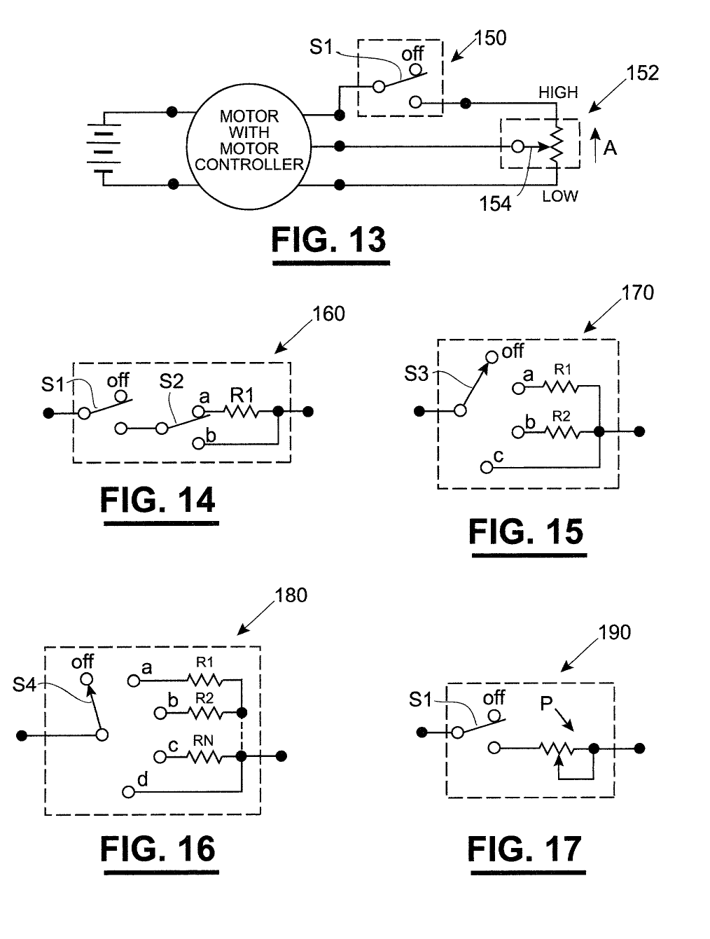

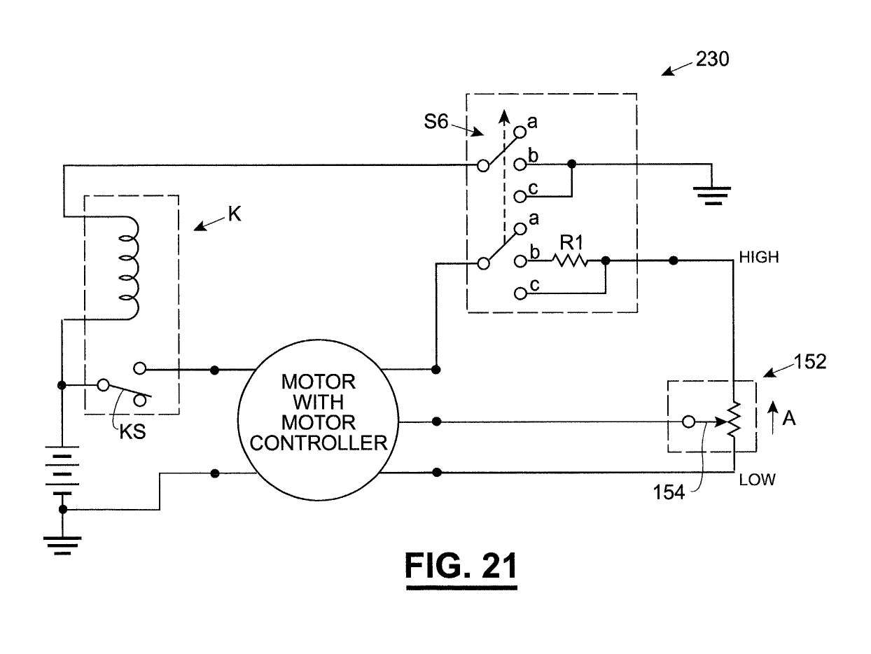

The electric scooter 30 of the present invention is illustrated in FIG. 1 with a twist throttle 32. It will be understood by one skilled in the art that the twist throttle 32 is a potentiometer. Rotating the twist throttle 32 along A moves the wiper of the potentiometer from the low side to the high side (See FIGS. 13 and 21). Thumb throttle potentiometers and trigger throttle potentiometers are also well known in the art.

It is well known in the prior art to provide a locking mechanism to prevent the telescoping handlebar mast 38 from collapsing against the deck lid 48 during use. In U.S. Pat. No. 5,848,660, a hydraulic gas spring strut is pivotally secured at one end to a steering assembly (referred to above as the telescoping handlebar mast 38) and at the other end to the frame. When extended, the collapsible strut locks the steering assembly in an upright operating position, and when the strut is in a compressed or collapsed position, it locks the steering assembly in a position generally parallel to the frame assembly for transporting or storing the scooter. It will be understood to one skilled in the art that a variety of approaches are known for locking the telescoping handlebar mast 38 in the upright position, and applicant's electric scooter with selectable speed ranges is adaptable to each approach.

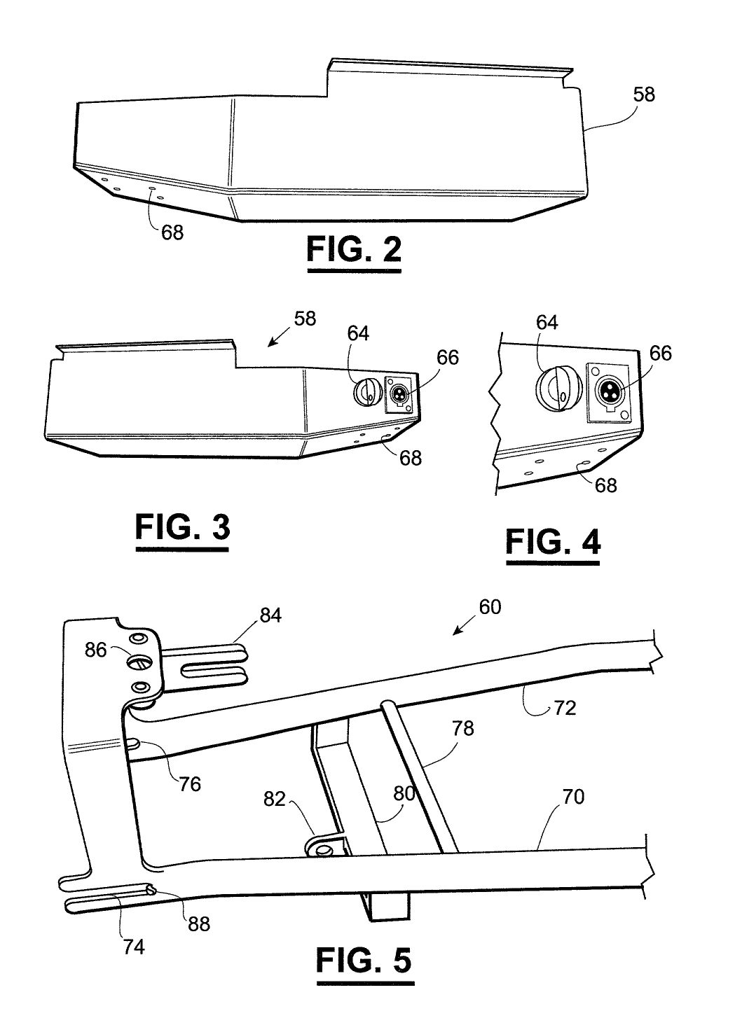

Referring now to FIGS. 2-4, additional views of the battery tray 58 show a keyswitch 64, an XLR panel mounted receptacle 66, and bolt holes 68. The XLR panel mounted receptacle 66 in the battery tray 58 is a standard receptacle adapted to receive a matching plug attached to a battery charger (not shown). The location of the receptacle 66 on the battery tray 58 permits the user to recharge the batteries without removing the deck lid 48.

The keyswitch 64, which will also be referred to herein sometimes as a switchlock, is a keyed rotary switch. The present invention contemplates several different models of switchlocks in conjunction with a variety of speed range controllers, as more fully illustrated in FIGS. 13-21.

Referring now to FIG. 5, the rear portion 60 of the frame 44 includes frame rails 70, 72, drive wheel axle slots 74, 76, crossmember 78, bottom motor mounting bracket 80 having an ear 82, brake assembly mount 84, and a Dzus fastener 86 (for attachment of the deck lid 48 by a quarter-turn rotation of a male portion of the Dzus fastener, not shown). Tabs 88 at the forward portion of drive wheel axle slots 74, 76 provide a reference position against which cams 132 (See FIGS. 8 and 9) are rotated to force the drive wheel 62 toward the rear of the frame 44, thereby tightening the toothed drive belt 128 (See FIGS. 8 and 9).

Referring now to FIGS. 6 and 7, shown therein is a motor assembly 100 which includes a brushless DC motor with integrated motor controller 102 having three mounting tabs 104 and a motor sprocket 106. A motor mounting plate 108 is attached to two of the mounting tabs 104 by bolts 110 and nuts 112. The motor mounting plate 108 includes an L-shaped member 114 having bolt holes 116 (See FIG. 8). The brushless DC motor 102 shown in FIGS. 6 and 7 includes an internal motor controller. The motor mounting plate 108 is firmly attached to the face of the brushless DC motor 102 and helps to remove heat from the brushless DC motor 102 to reduce overheating. Further cooling is provided by heat sinks 118 and blower 120, which directs air across the motor mounting plate 108 and the heat sinks 118 located on motor sprocket side of the motor mounting plate 108. A power connector 122 supplies power from a battery (not shown), and a three-wire connector 124 connects the internal motor controller to a speed range controller (See FIGS. 13-21) and the twist throttle 32 (See FIGS. 1, 13-21). Blower power leads 126 supply power from the battery (not shown) to the blower 120.

Referring now to FIGS. 8 and 9, the bolt 110 secures the motor mounting plate 108 to the ear 82 located on the lower motor mounting bracket 80. Additional bolts (not shown) disposed through bolt holes 116 in the L-shaped member 114 and through bolt holes 68 in the battery tray 58 secure the L-shaped member 114 of the motor mounting plate 108 to the battery tray 58. A toothed drive belt 128 transfers power from the rotating motor sprocket 106 to a rear wheel sprocket 130. A cam 132 is rotated against tab 134 until the toothed drive belt 128 is taut. When the toothed drive belt 128 is taut, the rear axle bolt 136 is tightened to secure the drive wheel 62 in the drive wheel axle slots 74, 76.

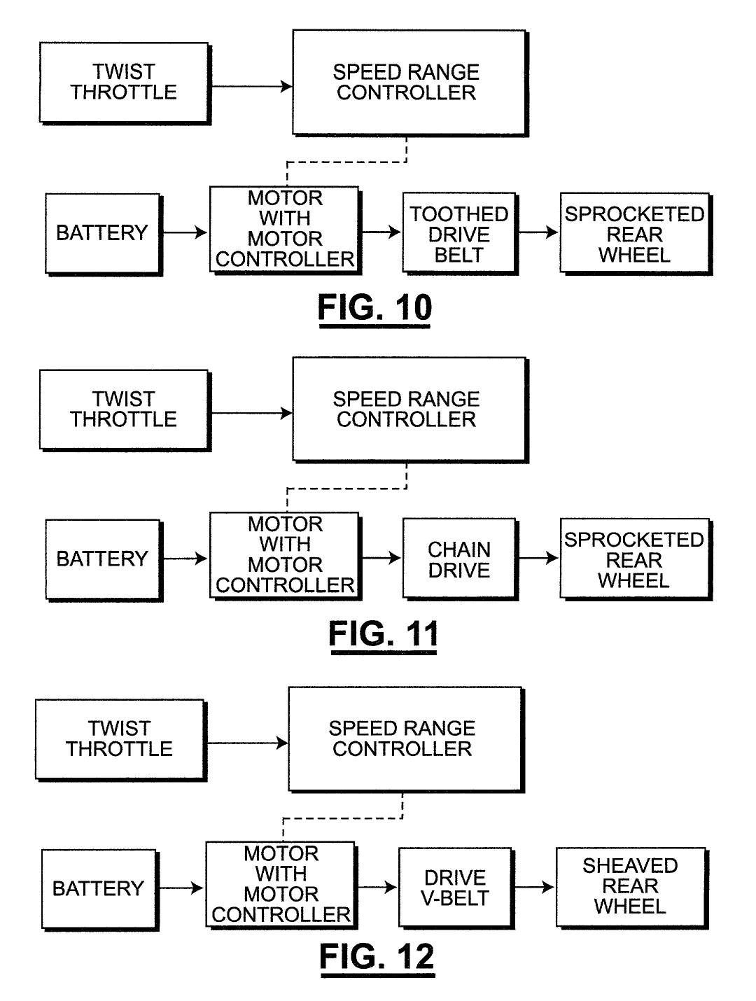

Referring now to FIGS. 10-12, shown therein are three common methods of transferring power from a motor with motor controller to the rear wheel (i.e., the drive wheel) of an electric scooter. FIG. 10 is a block diagram of the structure described in FIGS. 8 and 9. FIG. 11 illustrates the use of a drive chain to transfer power from the motor to a sprocketed rear wheel. FIG. 12 illustrates the use of a drive V-belt to transfer power from the motor to a sheaved rear wheel.

Referring now to FIG. 13, a speed range controller 150 provides a switch S1 for use in conjunction with a potentiometer 152. Rotation of the twist throttle 32 (See FIG. 1) along A moves a wiper 154 of the potentiometer 152. With the switch S1 in the off position, the input to the motor controller is disabled and the motor will not rotate. When the switch S1 is closed, the motor controller is enabled and the speed of the motor is determined by the position of the wiper 154 as dictated by the twist throttle 32. Thus the speed range controller 150 of FIG. 13 provides the electric scooter 30 with a single fixed speed range having a maximum speed dictated by the battery voltage and the motor specifications.

Still referring to FIG. 13, it will understood to one skilled in the art that switch S1 is a single-pole single-throw (SPST) switch. For purposes of illustration, S1 is depicted as having two positions to emphasize the on-off (i.e., enable-disable) operation.

FIGS. 14-20 illustrate additional speed range controllers according to the present invention. Like the speed range controller 150 shown in FIG. 13, each speed range controller in FIGS. 14-19 includes a switch having an off position, wherein the input to the motor controller is disabled and the motor will not rotate.

Referring now to FIG. 14, a speed range controller 160 has two fixed speed ranges. When the switch S1 is closed, a second switch S2 is in either position a or position b. When the switch S2 is in position a, the speed range controller 160 establishes a fixed speed range whereby the maximum speed of the motor (and, in turn, the maximum speed of the electric scooter 30) is limited to a speed less than the motor's maximum speed as a result of the presence of a resistor R1. When the switch S2 is in position b, the speed range controller 160 provides the electric scooter 30 with the second fixed speed range having a maximum speed dictated by the battery voltage and the motor specifications.

Referring now to FIG. 15, a speed range controller 170 has three fixed speed ranges. When the switch S3 is in position a, the speed range controller 170 establishes a fixed speed range whereby the maximum speed of the motor (and, in turn, the maximum speed of the electric scooter 30) is limited to a speed less than the motor's maximum speed as a result of the presence of a resistor R1. When the switch S3 is in position b, the speed range controller 170 establishes a fixed speed range whereby the maximum speed of the motor (and, in turn, the maximum speed of the electric scooter 30) is limited to a speed less than the motor's maximum speed as a result of the presence of a resistor R2. When the switch S3 is in position c, the speed range controller 170 provides the electric scooter 30 with the third fixed speed range having a maximum speed dictated by the battery voltage and the motor specifications.

Still referring to FIG. 15, if R2 is of less resistance than R1, then, as the switch S3 advances from position a to position b to position c, the maximum speed within the fixed speed range increases from a slow speed (position a), to a faster speed (position b), to the maximum speed of which the scooter is capable, as dictated by the battery voltage and the motor specifications (position c).

Referring now to FIG. 16, a speed range controller 180 has N+1 fixed speed ranges. When the switch S4 is in position a, the speed range controller 180 establishes a fixed speed range whereby the maximum speed of the motor (and, in turn, the maximum speed of the electric scooter 30) is limited to a speed less than the motor's maximum speed as a result of the presence of a resistor R1. When the switch S4 is in position b, the speed range controller 180 establishes a fixed speed range whereby the maximum speed of the motor (and, in turn, the maximum speed of the electric scooter 30) is limited to a speed less than the motor's maximum speed as a result of the presence of a resistor R2. When the switch S4 is in position c, the speed range controller 180 provides the electric scooter 30 with the N^{th} fixed speed range having a maximum speed dictated by the presence of a resistor RN. When the switch S4 is in position d, the speed range controller 180 provides the electric scooter 30 with the (N+1)^{th} fixed speed range having a maximum speed dictated by the battery voltage and the motor specifications.

Still referring to FIG. 16, if R2 is of less resistance than R1, and if RN is of less resistance than R2, then, as the switch S4 advances from position a to position b to position c to position d, the maximum speed within the speed range increases from a slow speed (position a), to a faster speed (position b), to a still faster speed (position c), to the maximum speed of which the scooter is capable, as dictated by the battery voltage and the motor specifications (position d).

Referring now to FIG. 17, a speed range controller 190 has a single variable speed range. When the switch S1 is closed, the speed range is determined by the potentiometer P. The potentiometer P functions as a variable resistor. When the resistance is at a minimum (i.e., zero ohms), the maximum speed is the maximum speed of which the scooter is capable, as dictated by the battery voltage and the motor specifications. As the resistance increases, a speed range is determined by each resistance value, and the maximum speed within each successive speed range decreases.

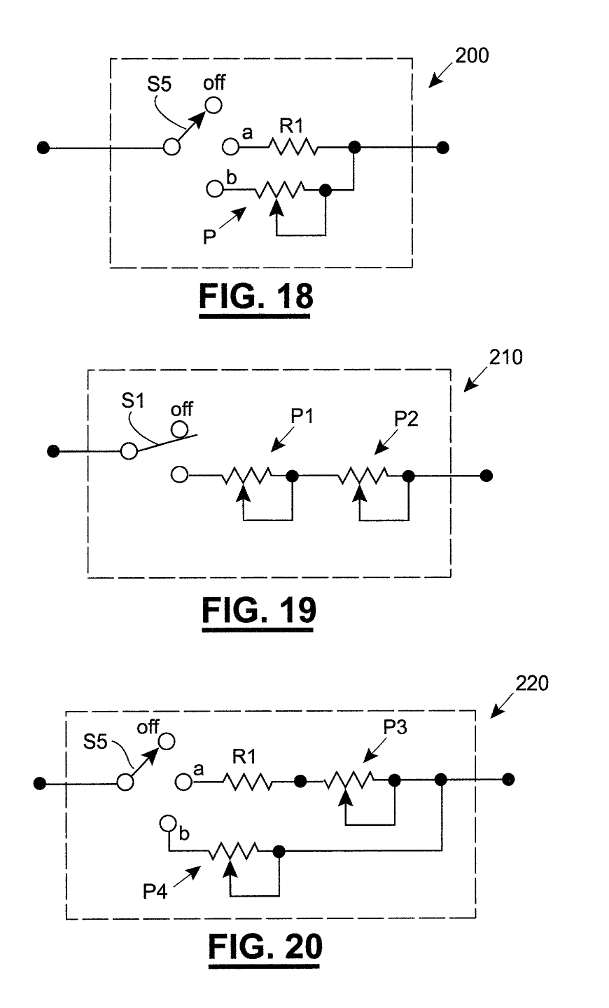

Referring now to FIG. 18, a speed range controller 200 has a fixed speed range and a variable speed range. When the switch S5 is in position a, the speed range controller 200 establishes a fixed speed range whereby the maximum speed of the motor (and, in turn, the maximum speed of the electric scooter 30) is limited to a speed less than the motor's maximum speed as a result of the presence of a resistor R1. When the switch S5 is in position b, a potentiometer P functions as a variable resistor. When the resistance is at a minimum (i.e., zero ohms), the maximum speed is the maximum speed of which the scooter is capable, as dictated by the battery voltage and the motor specifications. As the resistance increases, a speed range is determined by each resistance value, and the maximum speed within each successive speed range decreases.

Referring now to FIG. 19, a speed range controller 210 has two variable speed ranges wherein the first variable speed range has a maximum speed which is subject to the second variable speed range. When the switch S1 is closed, the speed range is determined both by potentiometers P1 and P2. In practice, a parent may wish to limit the maximum speed of the scooter 30 while permitting a child to further limit the maximum speed, subject to the maximum speed previously determined by the parent. For example, if the scooter is capable of a maximum speed of 20 mph, the parent may wish to limit the maximum speed achievable by the child to 10 mph. The child, in turn, may wish to limit his/her maximum speed to a value less than 10 mph. Assuming the parent-operated potentiometer is inaccessible to the child, the parent may be more comfortable in permitting the child access to the scooter.

Referring now to FIG. 20, a speed range controller 220 has two variable speed ranges. When the switch S5 is in position a, the maximum speed is determined by the combination of R1 and the resistance value established by a potentiometer P3 (which functions as a variable resistor). When the switch S5 is in position b, a potentiometer P4 functions as a variable resistor. When the resistance of P4 is at a minimum (i.e., zero ohms), the maximum speed is the maximum speed of which the scooter is capable, as dictated by the battery voltage and the motor specifications. As the resistance of P4 increases, a speed range is determined by each resistance value, and the maximum speed within each successive speed range decreases.

Referring now to FIGS. 13-20, and as stated above, each speed range controller in FIGS. 13-20 includes a switch having an off position, wherein the input to the motor controller is disabled and the motor will not rotate. When the switch is in the off position, the battery remains connected to the internal motor controller, thus creating a slight drain on the battery.

Referring now to FIG. 21, shown therein is a speed range controller 230 having two fixed speed ranges. The speed range controller 230 solves the problem of battery drain associated with the speed range controllers of FIGS. 13-20. A switch S6 has two poles and three positions, i.e., the switch S6 is a double-pole triple-throw switch. When the switch S6 is in position a, a normally open relay K is de-energized, the battery is disconnected from the motor by a switch KS, thereby de-energizing the motor and the motor controller, thus eliminating any drain on the battery.

Still referring to FIG. 21, when the switch S6 is in position b, the normally open relay K is energized, closing switch KS, connecting the battery to the internal motor controller. The speed range controller 230 establishes a fixed speed range whereby the maximum speed of the motor (and, in turn, the maximum speed of the electric scooter 30) is limited to a speed less than the motor's maximum speed as a result of the presence of a resistor R1. The speed of the motor, within this selected speed range, is determined by the position of the wiper 154 as dictated by the twist throttle 32.

Still referring to FIG. 21, when the switch S6 is in position c, the normally open relay K is energized, closing switch KS, connecting the battery to the internal motor controller. The speed range controller 230 provides the electric scooter 30 with a second fixed speed range having a maximum speed dictated by the battery voltage and the motor specifications.

Referring now generally to FIGS. 14-21, the selection of a speed range permits the rider to hold the twist throttle 32 in a full throttle position yet maintain a constant scooter speed less than the maximum speed dictated by battery voltage and motor specifications. In practical terms, the maximum speed within the selected speed range is a “cruising speed” or a “cruise control” speed at full throttle.

It will be understood by one skilled in the art that electric motors sometimes are powered by a simple on/off switch, but many types of electric motors are used in conjunction with motor controllers which use a potentiometer for variable speed control. In FIG. 1, the twist throttle 32, which serves as a throttle control, is a potentiometer. The throttle control is used at one position for no speed (i.e., no movement of the motor), and varies continuously through intermediate speeds to a maximum position corresponding to a maximum motor speed.

Some motors, such as those built by MAC Brushless Motor Company (Washington, Mo.), KollMorgen (Lakewood, Colo.), and TransMagnetics (Cotati, Calif.) have built-in motor controllers. Many motors, such as those built by Litton Poly-Scientific and Clifton Precision (Murphy, N.C.), use an external motor controller. Litton also makes a matching controller for its motors.

The motor controllers (whether internal or external) have three connections to the throttle control: Low (ground); High (+Voltage); and Wiper (Speed control voltage). The controllers are designed so that motor operation begins at a minimum speed at a certain minimum control voltage. If the control voltage is below a lower threshold value, the motor does not turn. If the control voltage exceeds a upper threshold value, the motor runs at maximum speed. One skilled in the art will recognize that the potentiometer 152 in FIGS. 13 and 21 varies the speed of the motor as described above.

By way of illustration, the TransMagnetics motor provides positive 6.25 volts to the high side of the throttle control, ground to the low side, and senses motor control voltage. The motor operation starts when the motor control voltage exceeds a lower threshold voltage of 1 to 1.5 volts, and maximum speed is reached when the motor control voltage exceeds 4 to 4.5 volts. So, with a 5 KΩ potentiometer throttle control, at minimum throttle opening the motor control voltage is 0 volts, and at maximum throttle opening the motor control voltage is 6.25 volts.

Referring now to FIG. 13, the motor controller applies a reference voltage across the potentiometer 152. The potentiometer 152 acts as a voltage divider with the position of the wiper 154 determining the value of the motor control voltage sensed by the motor controller. It will be understood by one skilled in the art that the switch S1 can be located at any convenient location in the motor control circuit (i.e., high side, wiper, or low side). The speed range controller 150 shown in FIG. 13 is a speed range controller only to the extent that, when the switch S1 is in the off position the motor control voltage is zero and when the switch S1 is closed the motor control voltage is determined by the position of the wiper 154. Thus, with switch S1 closed, the motor control voltage varies between 0 volts (motor speed 0 rpm) and the applied reference voltage (motor speed at maximum rpm).

According to the present invention, the speed range controllers 160, 170, 180, 190, 200, 210, 220, 230 enable the user to set the maximum control voltage to a value less than the reference voltage. In the absence of a speed range controller of the present invention, the reference voltage is applied across the potentiometer 152. The speed range controller causes the reference voltage to be applied across the speed range controller in series with the potentiometer 152. If the speed range controller includes a fixed resistor (either alone or in series with a variable resistor), the motor control voltage will always be less than the reference voltage. When the speed range controller is a variable resistor (See FIG. 17), the motor control voltage can equal the reference voltage when the variable resistor is set to 0 ohms (See FIGS. 14-21).

Referring now to FIGS. 14-21, illustrated therein is the use of resistors and potentiometers to control speed ranges. It will be understood by one skilled in the art that their specific values are selected in light of motor controller specifications. It will be further understood by one skilled in the art that, although the speed range controllers have been illustrated with a motor having an internal motor controller, the speed range controllers of the present invention are equally suited for motors using external motor controllers. It will be further understood by one skilled in the art that two or more of the speed range controllers described herein can be combined to achieve a particular goal. For example, the speed range controller 170 could be combined with the speed range controller 190 to provide three fixed speed ranges and one variable speed range.

As stated hereinabove, the present invention contemplates several different models of switchlocks (also referred to herein as keyswitches) in conjunction with a variety of speed range controllers. The simplest switch would be a single-pole single-throw (SPST) switch which connects/disconnects the high side of the motor controller, thereby resulting in an on/off switch operation (See FIG. 13). An example of this switch would be a C&K Y1011U2C203NQ switch, manufactured and distributed by C&K Components, Inc. A single pole double throw switch can be used as S2 in FIG. 14 to provide for slow/fast operation. Off, slow, and fast operation could be combined in a single switch using, for example, the C&K Y1907U2C203NQ switch, as S3 in FIG. 15.

Referring now to FIG. 14, a C&K Y1011U2C203NQ switch can be used as S1, then another switchlock can be used as S2. If S1 is a switchlock, a parent can turn the key off and remove it, thereby preventing a child from operating the electric scooter. In the alternative, the parent can close S1 and turn S2 to position a, so the child can ride the scooter—but only at a slow speed.

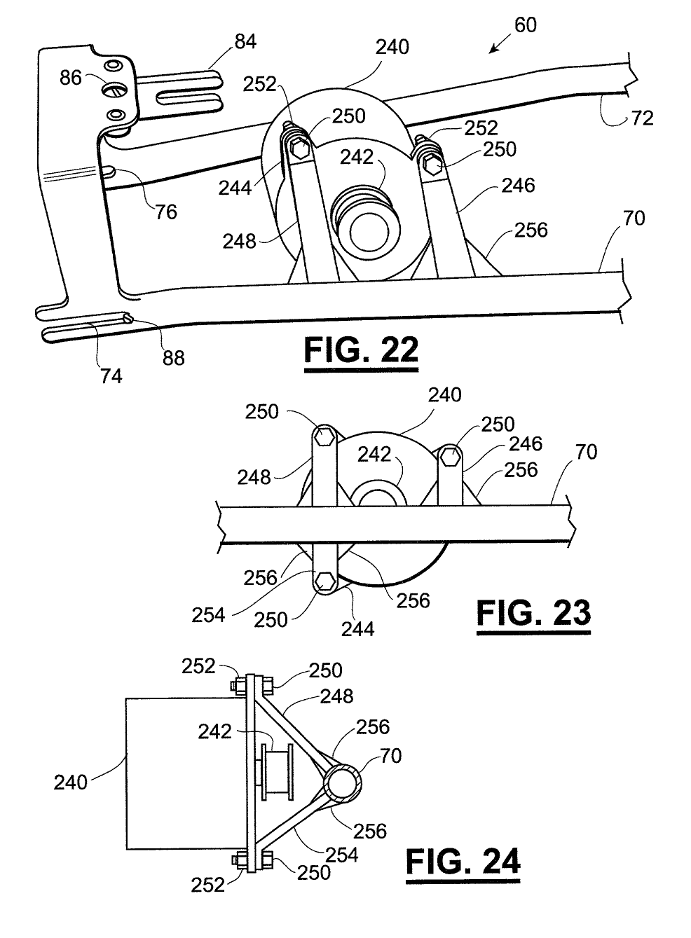

Referring now to FIGS. 22-24, shown therein is another embodiment of the present invention. A brushless DC motor 240 having a motor sprocket 242 and three mounting tabs 244 is secured to the frame rail 70 of the scooter frame 44 by struts 246, 248, and 254. The struts are attached to the frame rail 70 on one end and to the mounting tabs 244 on the other. Bolts 250 extend through bolt holes in the struts 246, 248, 254 and through bolt holes in the mounting tabs 244 and are held in place by nuts 252. Gussets 256 reinforce the joint of attachment of the struts 246, 248, 254 to the frame rail 70.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An improved electric scooter propelled by a battery-powered DC motor, wherein the speed of the DC motor is determined by a motor controller, the motor controller applies a reference voltage across a potentiometer and the potentiometer provides a motor control voltage to the motor controller, and the motor controller senses the motor control voltage and adjusts the speed of the DC motor based on the motor control voltage, the improvement comprising:
a speed range controller for selecting between a first speed range and a second speed range, said speed range controller further comprising a switch for switching between a first switch position wherein a fixed resistor is placed in series with the potentiometer and a second switch position wherein the potentiometer is the only resistance connected to the motor controller;
so that, in said first switch position the maximum control voltage sensed by the motor controller is reduced by the presence of said fixed resistor to a value less than the reference voltage, and the maximum speed of the DC motor within said first speed range is less than the maximum speed dictated by the battery voltage and the DC motor specifications, and in said second switch position the maximum control voltage sensed by the motor controller is the reference voltage, whereby the maximum speed of the DC motor is dictated by the battery voltage and the DC motor specifications.
